(19) United States
(12) Patent Application Publication
(10) Pub. No.: US 2014/0013841 A1
(43) Pub. Date: Jan. 16, 2014

(54) ABSOLUTE GRAVIMETRIC MEASUREMENT DEVICE BY ATOMIC INTERFEROMETRY FOR GEOPHYSICAL APPLICATIONS PARTICULARLY FOR MONITORING HYDROCARBON RESERVOIRS

(71) Applicants: Francesco Italiano, Roma (IT); Massimo Antonelli, Piacenza (IT); Guglielmo Maria Lucio Tino, Calenzano (IT); Fiodor Sorrentino, Pisa (IT); Marella De Angelis, Firenze (IT)

(72) Inventors: Francesco Italiano, Roma (IT); Massimo Antonelli, Piacenza (IT); Guglielmo Maria Lucio Tino, Calenzano (IT); Fiodor Sorrentino, Pisa (IT); Marella De Angelis, Firenze (IT)

(73) Assignee: ENI S.p.A., Roma (IT)

(21) Appl. No.: 13/977,442

(22) PCT Filed: Dec. 20, 2011
(86) PCT No.: PCT/IB2011/055814

§ 371 Date: Sep. 25, 2013

(30) Foreign Application Priority Data
Dec. 29, 2010 (IT) MI2010A002453

(51) Int. Cl. G01V 7/02

(52) U.S. Cl. CPC G01V 7/02
USPC 73/382 R

(57) ABSTRACT

An absolute gravimetric measurement device including, in succession, a laser system, a supporting surface of the laser system, an ultra-vacuum system, a retroreflective mirror, and a seismic attenuation system. The seismic attenuation system includes an upper plate including a hole above which the retroreflective mirror is kept suspended by at least three metallic blades including first ends constrained to a periphery of the plate and second ends above the hole in correspondence with the retroreflective mirror, the metallic blades configured to form a spring-antispring geometry for damping vibrations of the retroreflective mirror. The absolute gravimetric measurement device also includes a mechanism leveling the retroreflective mirror integral with the seismic attenuation system and a radial constraining mechanism between the retroreflective mirror and the upper plate.

The present invention relates to an absolute gravimetric measurement device by atomic interferometry particularly suitable for on-site applications and advantageously used in the geophysical field.

Gravimetry is nowadays also successfully applied in oil exploration, as well in the study of phenomena linked to the geomechanical field, hydrology or geodynamical processes thanks to the measurement of time variations of gravity acceleration.

It is known, in fact, that the Earth's gravity field varies with time and space.

More specifically, this force field varies in relation to the place considered, as it depends on the latitude, altitude and composition of the subsoil and is time-variant as it is influenced by various phenomena. Among these, it is worth citing geodynamic or tectonic phenomena, the attraction exerted by a body of the solar system, the attraction of ocean masses, the cyclic and the instantaneous changing of the Earth's rotation axis and the variation in atmospheric pressure.

This implies that a measurement of the gravity acceleration g and therefore a study of variations of the same entity in relation to time and space, can provide very accurate indications on various phenomena linked to the characteristics of the subsoil.

For these purposes, it is necessary to perform high-precision measurements, considering that the magnitudes of the signal to be measured are often lower than 20 microGal.

It is for this reason that, over the years, attempts have been made to produce devices for gravimetric measurements, or gravimeters, suitable for providing increasingly accurate and precise measurements.

Is useful to point out, however, that the requested accuracy degree varies according to the phenomenon to be analyzed.

For the study of the deep geological layers, for example, it is sufficient to use a gravimeter capable of providing measurements having a sensitivity (Δg/g) ranging from 10⁻⁶ to 10⁻⁶, whereas for the analysis of the geodynamic processes, the movements of volcanic magma, the variations in water-bearing layers and gravimetric tides, the measurements must have a sensitivity ranging from 10⁻⁷ to 10⁻⁸.

The absolute gravimetric measurement devices which are currently used are based on a technology which reached its maturity during the seventies'.

More specifically, the majority of known gravimeters are of the “free-fall” type and carry out the measurement of the gravity acceleration to which a body in free-fall is subjected, by means of optical interferometry techniques.

The sensitivity which can be reached by this type of gravimeter is about 10⁻⁸ and is mainly limited through the specific requirement of a contemporaneous verticality of the falling body and arm of the interferometer for measuring the space covered, as well as by a limited knowledge of the magnetic and electrostatic effects on macroscopic bodies.

Furthermore, the long period between one measurement and another makes this type of gravimeter unsuitable for performing a series of measurements under the same environmental conditions.

A new generation of instruments is represented by superconductor gravimeters, wherein the weight of a niobium sphere is balanced by a force produced by the current of a superconductive coil.

From the measurement of the current variations necessary for keeping the sphere in its initial position, it is possible to obtain an estimation of the variations in the gravity acceleration.

Gravimeters based on this principle have a high precision, but they are relative measurement instruments as they do not provide a direct measurement of the gravity acceleration and also require a calibration of the weight of the reference sphere with respect to the absolute standards.

Furthermore, also in superconductor gravimetric measurement devices, the accelerated mass is a macroscopic object and therefore the measurement suffers from limits due to a scarce knowledge of the magnetic and electrostatic effects, in addition to limits due to thermal drifts and transportability limits due to the necessary support of the cryogenic apparatus.

In order to overcome the accuracy limits of optical interferometry gravimeters and the drawbacks due to a limited knowledge of magnetic and electrostatic effects providing an absolute measurement of the gravity acceleration, absolute gravimetric measurement devices by atomic interferometry are currently used.

Atomic interferometers have proved to be extremely accurate acceleration and rotation sensors and in an applicative field are already competitive with respect to optical interferometers in the measurement of gravity acceleration.

This depends on the fact that in a gravimeter based on interferometry of matter waves with neutral atoms, the accelerated element is the atom itself and there are no macroscopic elements in movement; systematic errors due to magnetic and electric effects can therefore be controlled by an accurate knowledge of the atomic structure.

Another important advantage in absolute gravimetric measurement devices by atomic interferometry lies in the absence of instrumental drifts which therefore permits long functioning periods without external adjustment interventions and measurement integrations over long periods of time for increasing the sensitivity which could potentially reach a value equal to about 10⁻¹¹.

In an absolute gravimetric measurement device by atomic interferometry, a sample of atoms is cooled using the pressure deriving from a light radiation almost resonant with an atomic transition.

The cooling or slowing-down process brings the atoms to such low temperatures (a few micro-Kelvin) that the undulating nature of the matter, in particular the atoms, becomes significant and the corresponding de Broglie wavelength can be comparable to the distance among the atoms.

This permits experiments to be carried out in which the matter waves interfere like light waves in optical interferometry.

It can therefore be affirmed that unlike optical interferometry gravimeters, in absolute gravimetric measurement devices by atomic interferometry, the acceleration of a body in free fall is not measured but rather of a plurality of atoms.

This plurality of atoms is first cooled and entrapped in a forced vacuum chamber, with the use of a plurality of laser bands conformant for certain frequencies, capable of creating a three-dimensional magneto-optical trap (3D-MOT).

After entrapment, the plurality of atoms is released and becomes object of an interferometric sequence.

More specifically, during the interferometric sequence, the atoms are separated into two atomic bands which, after following different paths, are recombined.

Unlike optical interferometry, in atomic interferometry the separators and deflectors of the band of atoms are produced through a succession of laser impulses emitted at intervals of time T.

The use of Raman interferometry in the above gravimeters is nowadays known, which is produced through the interaction of two counter-propagating laser bands the frequency difference of which corresponds to a transition between two hyperfine levels of the fundamental state of the atomic species considered.

In this respect, it should be noted that the atomic species which best adapt to application in an atomic interferometry gravimeter are alkaline metals, and in particular Caesium and Rubidium which have a pair of levels having a very long average life, between which Raman transitions can be induced and which are easily vaporizable and manageable for the purposes of cooling and laser entrapment.

After the interferometric sequence, a detection step is performed, through which the acceleration to which a plurality of atoms is subjected, can be estimated.

Is useful to point out that after the interferometric sequence, in fact, the atoms are on the two above hyperfine levels of the fundamental state. A step shift term ΔΦ between the matter waves associated with the recombined atomic bands can be obtained from the ratio between the number of atoms present on said two hyperfine levels, which is proportional to the product gT². It is therefore possible to obtain a measurement of the gravity acceleration from the measurement of said phase shift during the detection step.

Performing the detection step according to the simultaneous detection technique in separate areas, and separate areas sequential detection, is currently known.

More specifically, according to the separate area sequential detection, the plurality of atoms crosses two areas in sequence in free fall, wherein the atoms of the two hyperfine levels are selectively excited through detection bands which stimulate a fluorescence emission, the intensity of which is proportional to the number of atoms present in the two levels.

Simultaneous detection in separate areas, on the contrary, requires the use of thrust laser bands to spatially separate the atomic bands corresponding to the atoms in the above two hyperfine levels and detection bands which stimulate an emission of fluorescence, the intensity of which is proportional to the number of atoms present in the two bands.

All laser bands involved in the steps described so far are generated by laser systems the complexity of which generally increases with the accuracy requisites required.

Laser systems implemented in current atomic interferometry gravimeters generally comprise at least three laser sources associated with a plurality of mirrors, modulators, optical fibres and in step and/or in frequency connection means of the relative light bands.

With an increase in the number of light sources present in the laser system, an increase obviously occurs in the encumbrance of the same and the relative gravimeter, making it practically impossible to move it.

Such complex laser systems are, in fact, generally implemented on extremely large and heavy optical benches which cannot be easily moved for perform a plurality of measurements in different places.

It should also be pointed out that the greater the time interval in which to perform the measurements, the higher the accuracy of an atomic interferometric gravimeter will be; such time interval obviously depends on the space covered by the atoms in free fall.

Furthermore the accuracy improves if a control of the position and velocity of the cooled atoms at the moment of their release from the three-dimensional magneto-optical trap, can be carried out.

In order to increase the time interval useful for performing measurements on the sample of atoms, a release technique called atomic fountain is currently implemented in atomic interferometry gravimeters.

According to this release technique, the laser system is piloted so that at the end of the entrapment in the magneto-optical trap, the magnetic field is extinguished and the radiation pressure due to the laser bands of the trap is subsequently unbalanced; the cooled atoms are therefore thrust upwards in a vertical direction creating an atomic fountain.

This fountain release technique offers the advantage of doubling the time interval useful for carrying out the interferometric sequence and detection, but it does not permit the position and initial velocity of the atoms to be controlled with precision.

Furthermore, is useful to point out that the fountain release technique requires an ultra-vacuum system having considerable dimensions, as it must include the whole path that the sample of atoms must follow.

The atomic interferometry gravimeters currently in use are therefore large-dimensioned laboratory measurement systems having a high accuracy.

Starting from above downwards, following the vertical direction defined by the force of gravity, the absolute gravimetric measurement device of the present invention, as also the known devices, generally comprises a laser system for the generation of laser bands, a supporting plane for the laser system, an ultra-vacuum for the passage of the laser bands and a retroreflective mirror situated at the base of the ultra-vacuum system.

In order to guarantee a high measurement accuracy, it is necessary to reduce the vibrations of the absolute gravimetric measurement device along its vertical axis, to the minimum, in particular vibrations along the vertical direction of the retroreflective mirror, and also to keep the above components of the absolute gravimetric measurement device as aligned as possible along said vertical direction.

For this purpose, seismic attenuation systems are known, of the type comprising spring-anti-spring suspension devices of the retroreflective mirror.

All the seismic attenuation systems currently known, however, have dimensions which are such that they cannot be integrated in an absolute gravimetric measurement device with low encumbrances according to the present invention.

An objective of the present invention is therefore to provide an absolute gravimetric measurement device equipped with a seismic attenuation system alternative to those known which, on the one hand, has a reduced encumbrance and on the other reduces vibrations along the vertical direction of the retroreflective mirror to the minimum, maintaining the components of the absolute gravimetric measurement device as aligned as possible along the vertical direction.

These objectives according to the present invention are achieved by providing an absolute gravimetric measurement device by atomic interferometry comprising a seismic attenuation system as specified in the claims.

Further characteristics of the invention are indicated in the dependent claims.

The characteristics and advantages of an absolute gravimetric measurement device according to the present invention will appear more evident from the following illustrative and non-limiting description, referring to the enclosed schematic drawings, wherein:

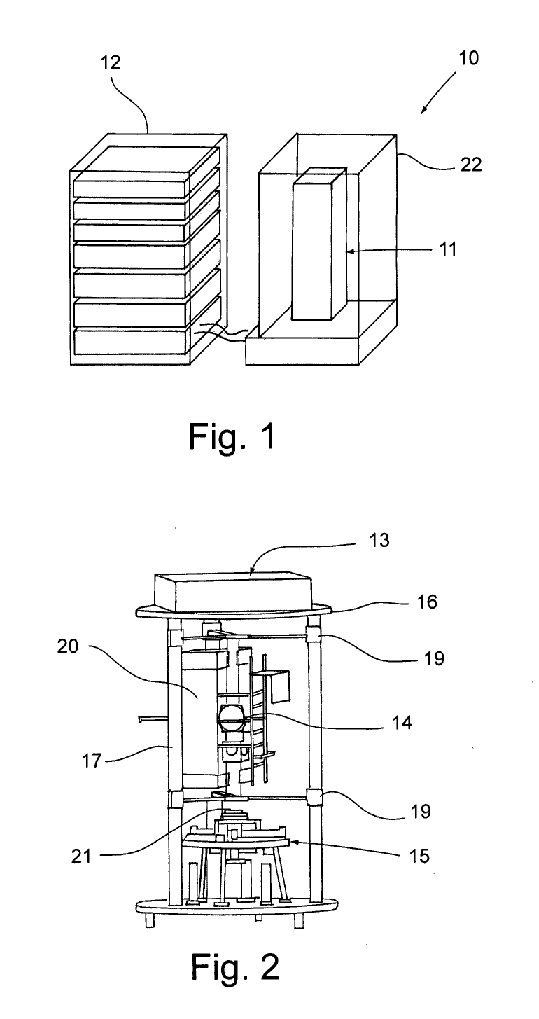

FIG. 1 is a schematic perspective view of an absolute gravimetric measurement device by atomic interferometry for geophysical applications according to the present invention;

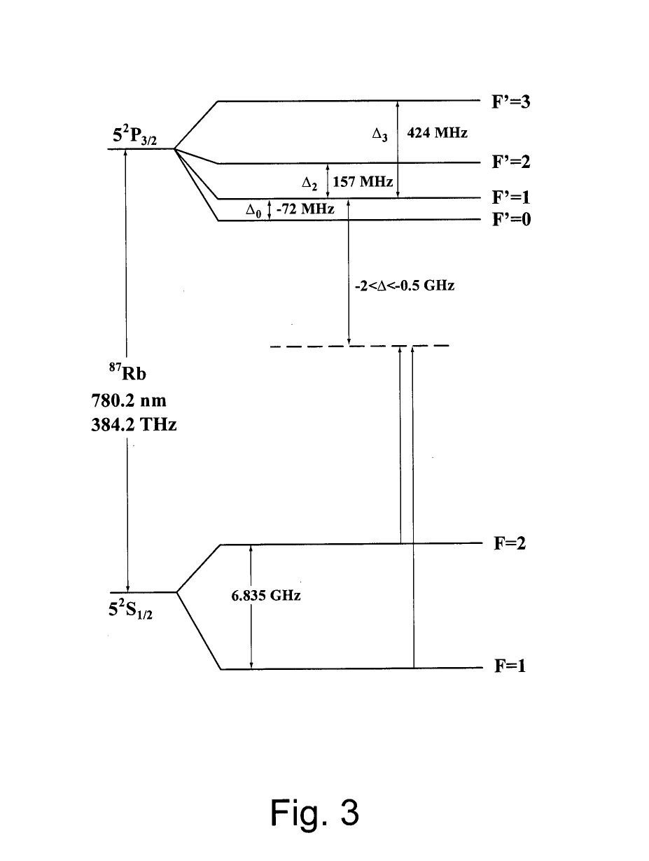

FIG. 2 is a schematic perspective view of a measurement head included in the absolute gravimetric measurement device of FIG. 1;

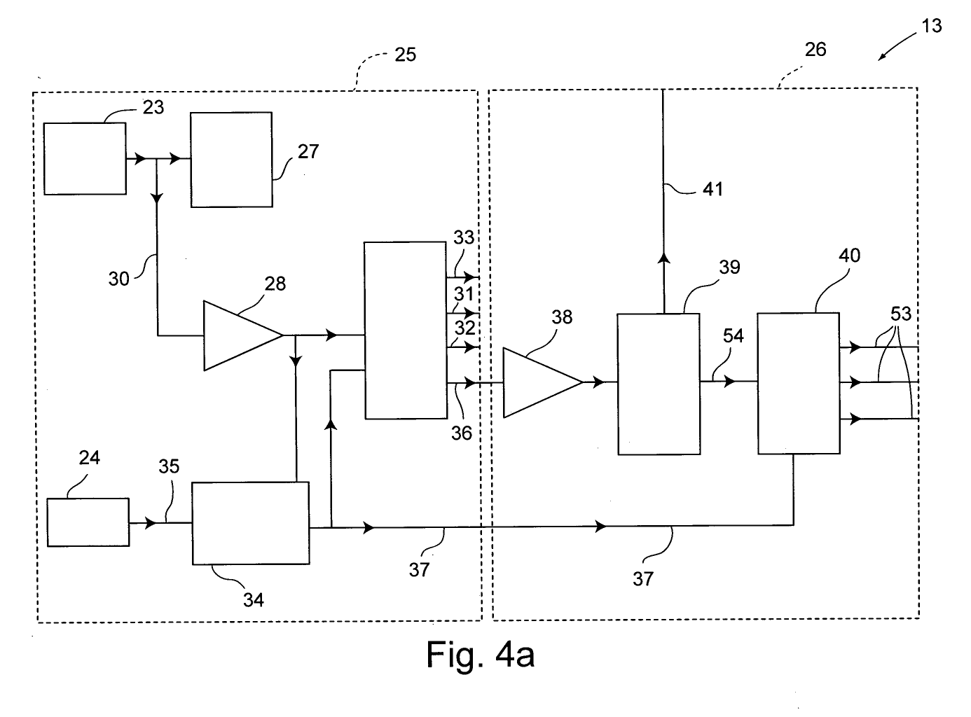

FIG. 3 is a Rubidium energy diagram;

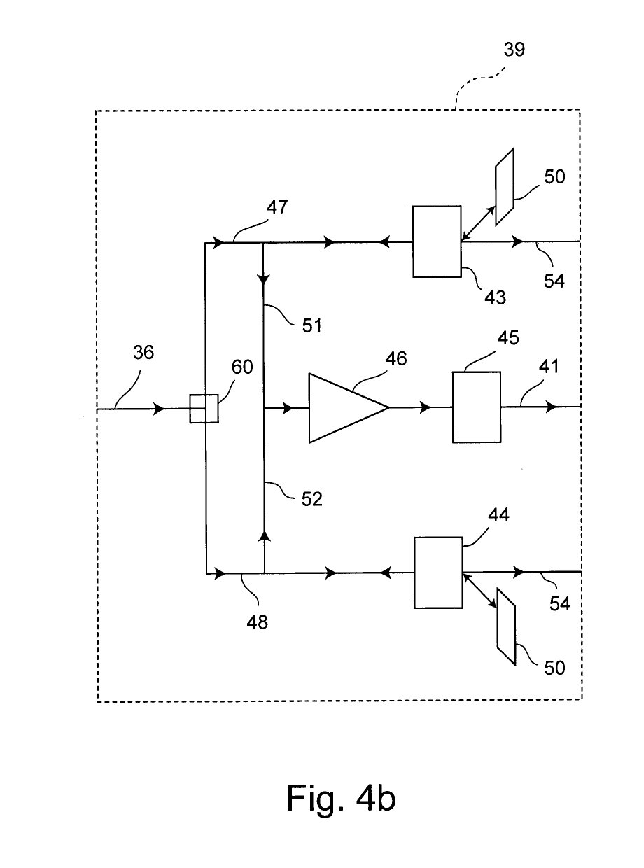

FIG. 4a is a schematic view of a laser system included in the measurement head of FIG. 2;

FIG. 4b is a schematic view of means for the generation of Raman bands included in the laser system of FIG. 4a;

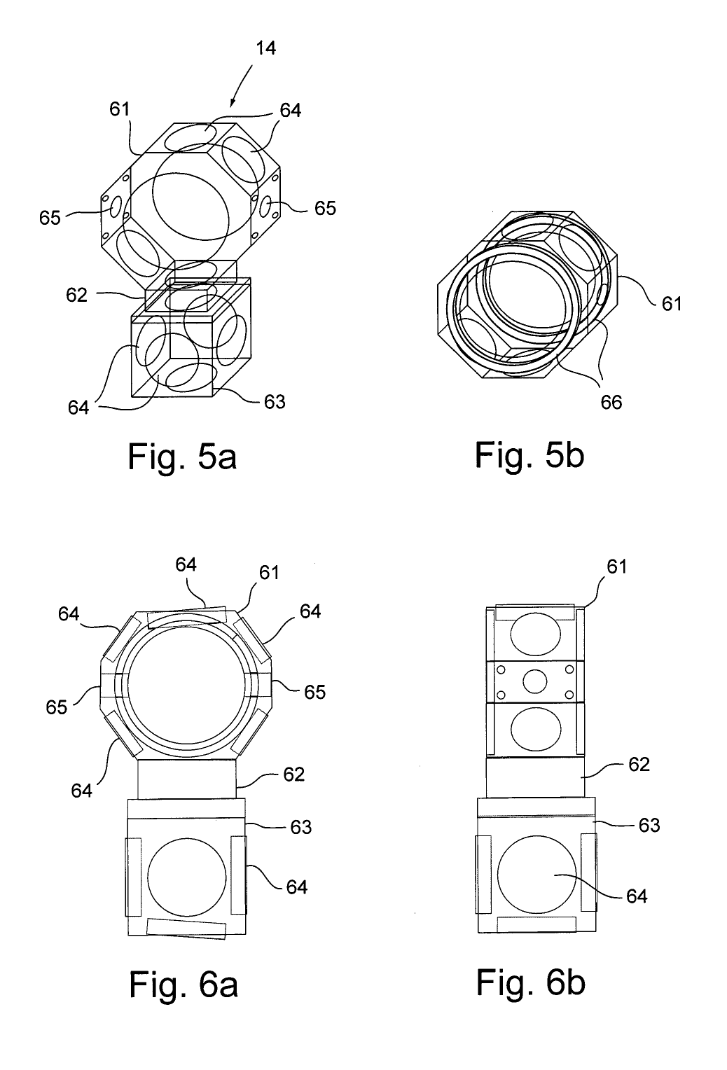

FIG. 5a is a schematic perspective view of an ultra-vacuum system included in the measurement head of FIG. 2;

FIG. 5b is a schematic view of a detail of a primary chamber included in the system of FIG. 5a;

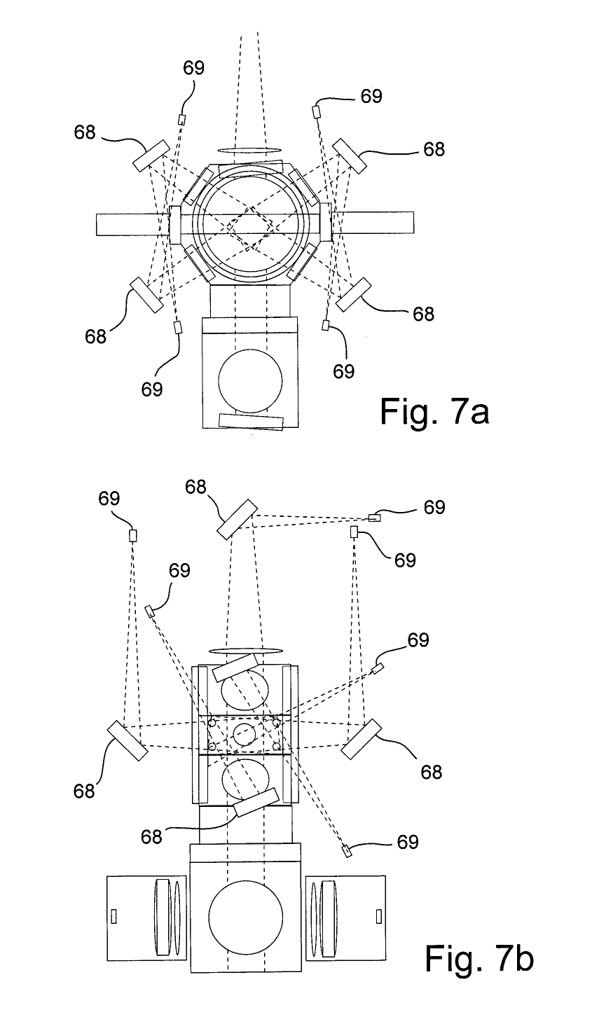

FIGS. 6a and 6b are two raised front and side views of the ultra-vacuum system of FIG. 5a;

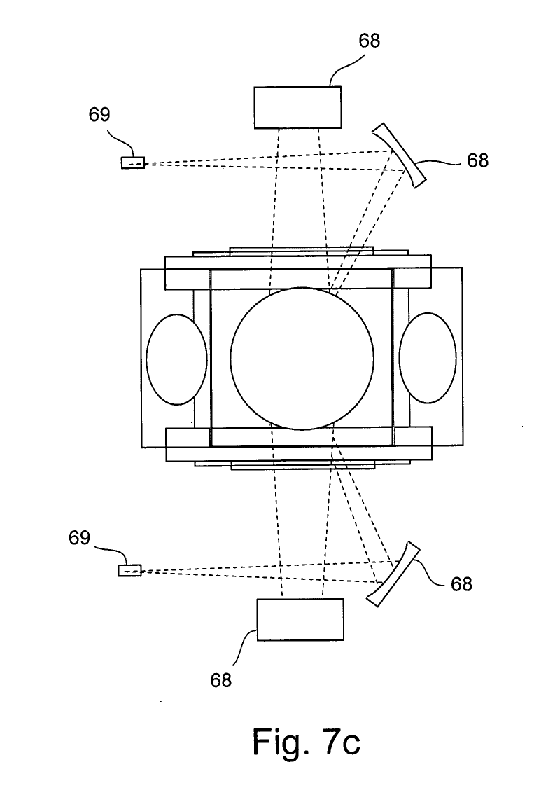

FIGS. 7a, 7b and 7c are respectively a schematic front view, side view and view from above of the ultra-vacuum system during the entrapment step;

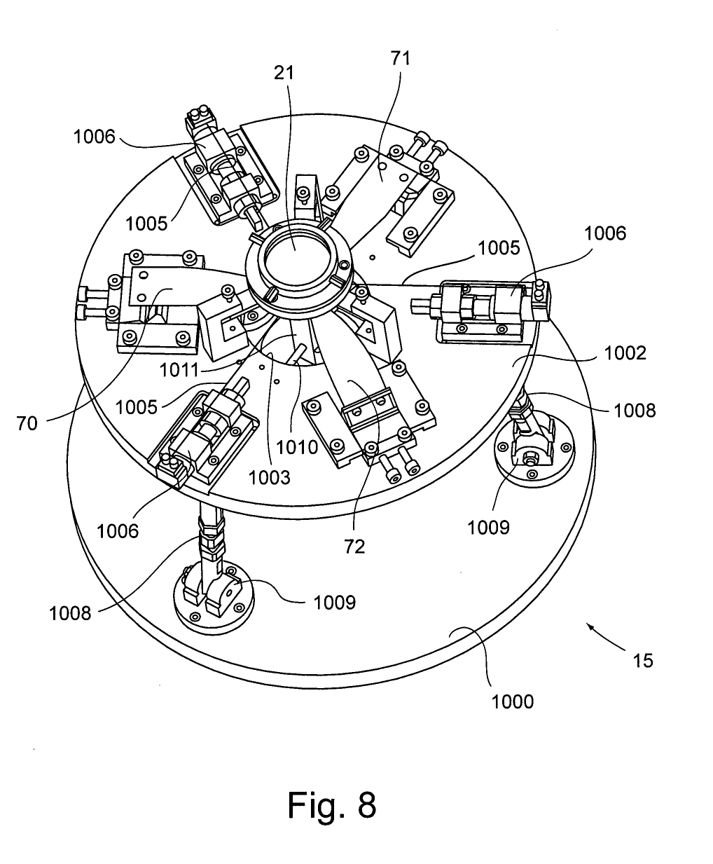

FIG. 8 is a schematic perspective view of a seismic attenuation system included in the measurement head of FIG. 2;

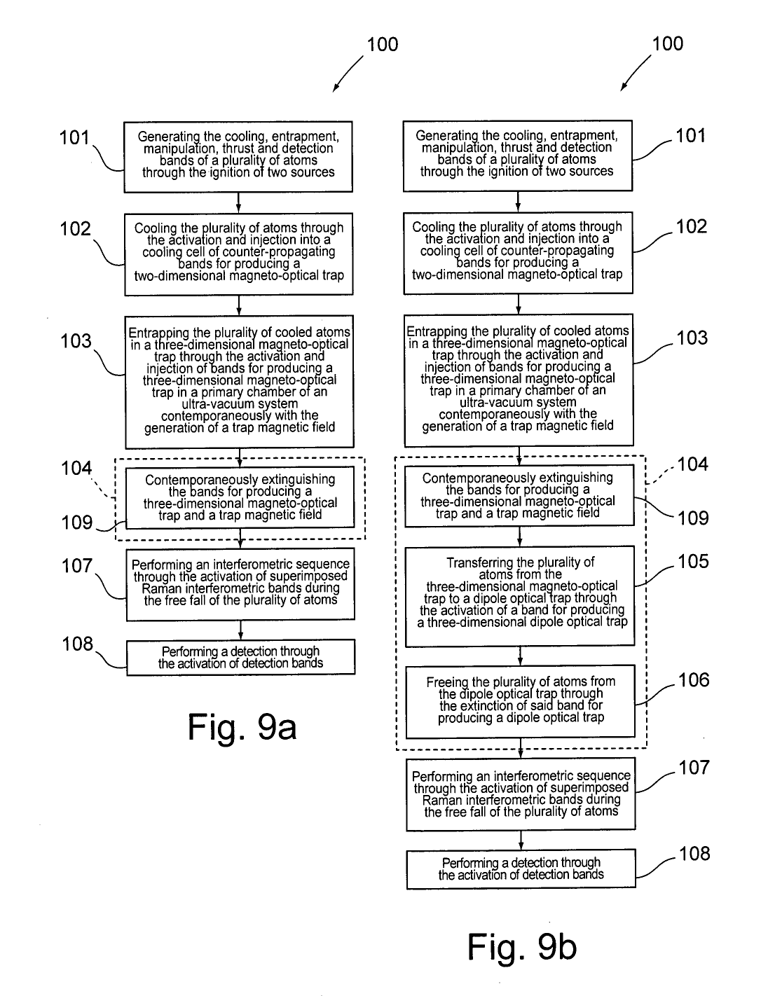

FIGS. 9a and 9b are two block schemes of two embodiments of a piloting method of the laser system of FIG. 4a;

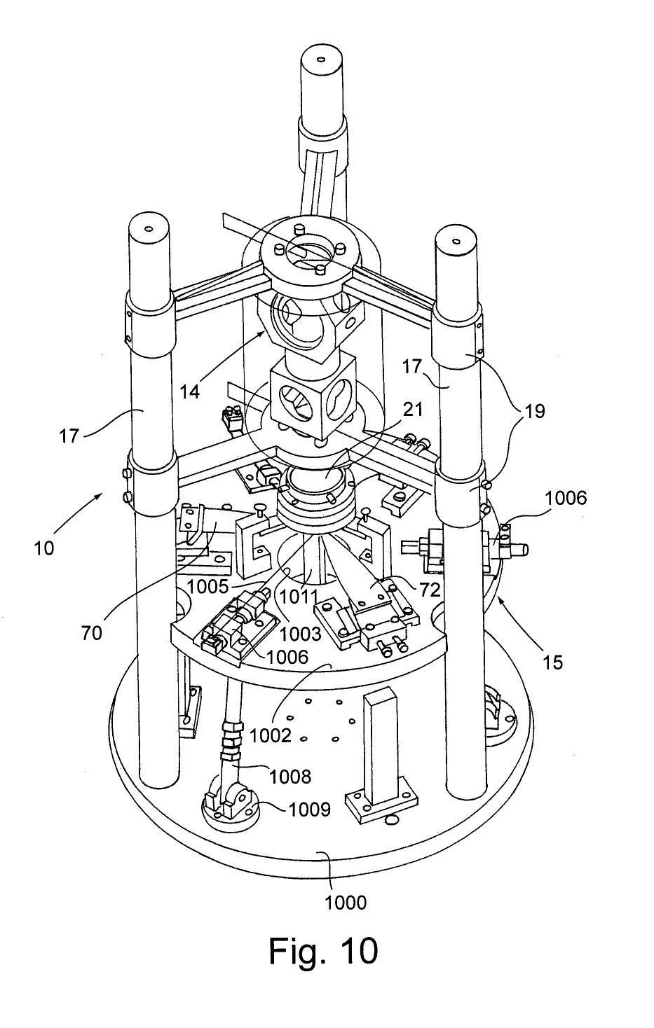

FIG. 10 is a schematic perspective view from above of the seismic attenuation system of FIG. 8 installed in the absolute gravimetric measurement device of the present invention; and

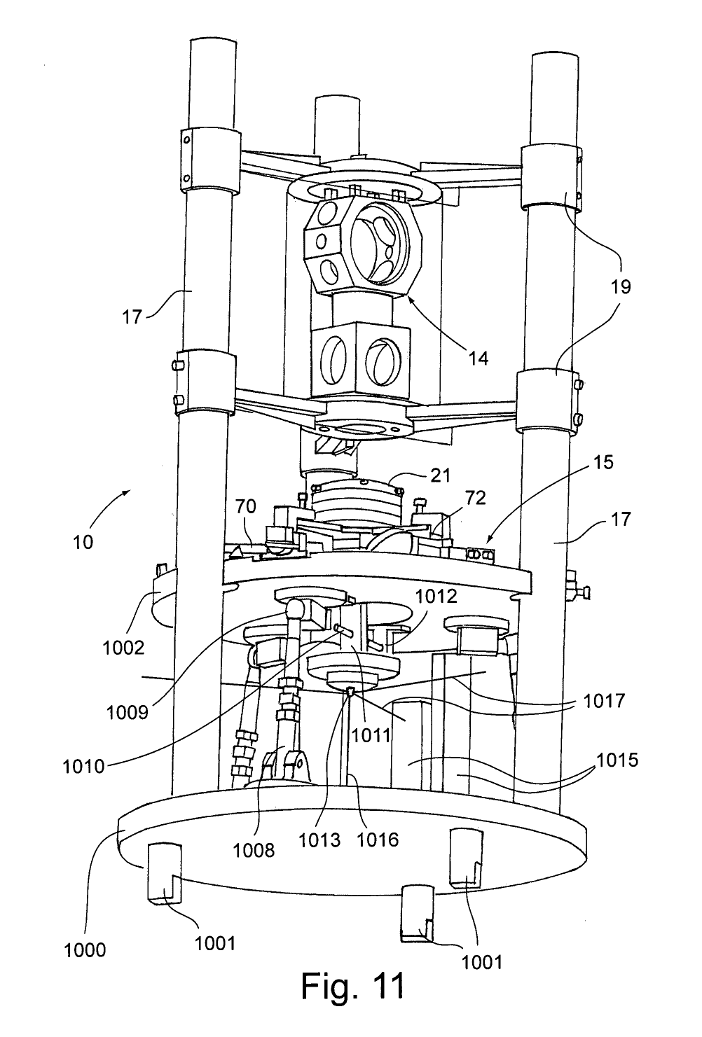

FIG. 11 is a schematic perspective view from below of the seismic attenuation system of FIG. 8 installed in the absolute gravimetric measurement device of the present invention.

With reference to the figures, an absolute gravimetric measurement device by atomic interferometry for geophysical applications is shown and indicated as a whole with 10.

Said absolute gravimetric measurement device by atomic interferometry 10 for geophysical applications comprises a measurement head 11 and a control and supplying rack 12 connected to each other by means of electric wires and possibly optical fibres (not illustrated).

The measurement head 11 of the absolute gravimetric measurement device by atomic interferometry 10 comprises an ultra-vacuum system 14 for entrapping the cooled atom sample and free fall of the same, as well as a seismic attenuation system 15 for controlling the vibrations.

The absolute gravimetric measurement device by atomic interferometry 10 also comprises a laser system for generating bands for the cooling, entrapment, manipulation and detection of atoms and an electronic control system (not illustrated) which can be included in the measurement head 11 or in the control and supplying rack 12.

In case the laser system 13 is included in the measurement head 11, optical fibres for transporting the bands generated by the laser system 13, are also included in the measurement head 11, and the rack 12 is therefore connected to the measurement head 11 only by means of electric wires.

In the preferred embodiment illustrated, the measurement head 11 comprises a vertical development frame 17, at the upper end of which a supporting plane 16 is constrained.

A metallic casing containing the laser system 13 is fixed on the upper supporting plane 16.

The ultra-vacuum system 14 enclosed in a magneto-screening casing 20 is constrained to the frame 17, below the upper supporting plane 16, by means of engagement and supporting means 19.

The seismic attenuation system 15 is constrained at the lower end of the frame 17.

Said seismic attenuation system 15 supports a retroreflective mirror 21 used for reflecting the interferometric bands.

The measurement head 11 is advantageously positioned inside a thermostat-regulated frame 22 or a metallic casing 22 with which temperature sensors and resistances are associated for compensating any possible temperature drops.

In this way, it is possible to actively control the temperature of the ultra-vacuum chamber 14 and above all the laser system 13; in particular, effects due to thermal fluctuations of the optical fibres used for transferring the plurality of bands generated by the laser system 13 to the ultra-vacuum system 14, are reduced.

More specifically, the laser system 13 is capable of generating and controlling the bands for the cooling and entrapment of a sample of atoms, optical repumping bands, Raman interferometric bands and thrust and detection bands.

These laser bands are suitably conformant with various frequencies which are determined on the basis of the resonant optical frequencies of the atomic species considered and specific function to be exerted.

Is useful to point out that the atomic species used in the absolute gravimetric measurement device 10 are characterized by a fundamental energy state and an excited energy state; each of these two energy states can be further divided into a plurality of hyperfine levels.

The atomic species used in the absolute gravimetric measurement device by atomic interferometry 10 for geophysical applications according to the invention is preferably Rubidium 87 which, as it can be observed in FIG. 3, has a fundamental energy state 5²S_{1/2} and an excited level 5²P_{3/2} which differ in frequency by 384.2 THz, or 780.2 nm.

Furthermore, each of these two levels comprises a plurality of hyperfine sublevels; in particular, the two hyperfine levels of the fundamental state F₁ and F₂ differ in frequency by 6.8 GHz as it can be clearly seen in FIG. 3.

The laser bands generated by the laser system 13 are approximately conformant with the frequency corresponding to the energy transition between the fundamental state and excited state, i.e. at 780.2 nm in the case of Rubidium 87.

In particular, depending on their function, the bands are tuned to the frequencies corresponding to the energy transitions between the hyperfine levels of the fundamental state and the hyperfine levels of the excited state of the atomic species considered.

More specifically, with reference to the energy diagram of Rubidium 87 illustrated in FIG. 3, the cooling and entrapment, as well as the thrust of the sample of atoms occur by means of laser bands which have a frequency equal to that of the energy transition between a second hyperfine level F₂ of the fundamental state 5²S_{1/2} and a third hyperfine level F′₃ of the excited level 5²P_{3/2}.

As a non-null probability exists that some atoms perform other transitions in addition to the cooling one, it is advisable to carry out a repumping to prevent said atoms from escaping the cooling itself.

The repumping band is set on the energy transition between a first hyperfine level F₁ of the fundamental state 5²S_{1/2} and a second hyperfine level F′₂ of the excited level 5²P_{3/2}.

The bands which realize the Raman interferometric sequence are set on the two energy transitions which take place between a virtual energy level and the first F₁ and second F₂ hyperfine level of the fundamental state 5²S_{1/2}. In the case of Rubidium 87, the two interferometric bands are therefore tuned to two frequencies which differ by about 6.8 GHz.

The detection bands are set on the energy transition between the second hyperfine level F₂ of the fundamental state 5²S_{1/2} and the third hyperfine level F′₃ of the excited level 5²P₃₁₂.

According to the present invention, the above plurality of laser bands is generated by a laser system 13 comprising only two laser sources 23, 24, preferably tuned to about 780.2 nm in case a sample of Rubidium 87 atoms is considered. The type of laser source is obviously selected on the basis of the requirements in terms of spectral purity, conformability and optical power which must satisfy the laser bands coming from the same sources.

In particular, the laser sources must have a narrower emission band with respect to the optical transitions involved.

Such requirement is extremely important especially for sources which generate bands for Raman interferometry and detection, as the frequency noise of these bands becomes step noise of the interferometer and measurement noise during the detection.

Laser sources stabilized at a level of about 1 MHz must therefore be used.

In light of this, the first source 23 is advantageously an external-cavity laser diode or ECDL, which can be stabilized with high precision and having a very narrow emission band; more specifically the absolute frequency f_{ref} of this external-cavity laser diode is comprised within the frequency range of [384227935.0 MHz, 384227935.5 MHz].

The second source 24 is preferably a distributed feedback laser or DFB, characterized by compact dimensions but by a greater band emission width with respect to an external-cavity laser diode; the absolute frequency fᵣₑₚ of the distributed feedback laser is comprised within the range of [384234682 MHz, 384234684 MHz].

An important difference between the two types of laser sources consists in the greater robustness of external-cavity laser diodes with respect to distributed feedback lasers. External-cavity laser diodes are in fact more subject to mode jumps as a result of mechanical, thermal or electric excitations; a mode jump leads to a loss in the frequency connection of the laser; the frequency connection operation is therefore generally less complicated with a distributed feedback laser, for which it is consequently sufficient to act on the injection current, an operation which can be easily automated. For an external-cavity laser diode, on the contrary, it may be necessary to act on three parameters such as temperature, current and piezoelectric voltage.

The bands for cooling, entrapment, interferometric sequence and detection, which differ in frequency by a controlled quantity with a precision in the order of 1 kHz, derive from the first source 23; the repumping bands derive from the second source 24.

The laser system 13 comprises a first module 25 and a second module 26 wherein the two sources 23, 24 and all the means necessary for generating the above laser bands, such as for example mirrors, polarizers, lenses, photodiodes and so forth, are positioned.

It should be noted that the configuration of the laser system 13 according to the present invention varies with a variation in the positioning of the sources 23, 24 inside the modules 25 and 26, but not beyond in the scope of the present invention.

In a preferred embodiment of the present invention, the two sources 23, 24 are placed inside the first module 25.

In this case, the first module 25 is capable of generating three-dimensional magneto-optical entrapment bands, thrust bands, detection bands and the repumping band, as well as a reference band for generating Raman interferometric laser bands.

More specifically, the first source 23 is advantageously associated with frequency connection means 27 capable of stabilizing a first band emitted 30 at a frequency shifted by a few hundreds of MHz with respect to the characteristic frequency of an energy transition of the atomic species considered.

The frequency connection means 27 are preferably capable of implementing the Modulation Transfer Spectroscopy (MTS) technique. According to this technique, a part of the band emitted by the first source 23 is separated into two bands, a pump band and a probe band. The pump band passes through an electro-optical modulator crystal or EOM (not illustrated) included in the frequency connection means 27. This electro-optical modulator crystal is capable of producing a pure step modulation, without an amplitude modulation. The modulation frequency is in the order of the natural broadness of the optical transition between the fundamental energy state and the excited energy state of the atomic species considered; in case said atomic species is Rubidium 87, the saturation frequency is therefore about 6 MHz. The electro-optical modulator crystal is associated with a cell (not illustrated) with Rubidium 87 vapour into which the pump band is injected after the electro-optical modulation.

Is stressed that the electro-optical modulator crystal permits a pure step modulation without AM modulation, therefore with a high reinjection degree of the offsets in the error signal.

The probe band, on the other hand, passes through an acousto-optic modulator crystal (not illustrated), included in the frequency connection means 27, which produces a pure frequency translation with a modulation frequency preferably equal to 360 MHz. After being modulated, such probe band is superimposed in an opposite direction with respect to the pump band inside the Rubidium 87 vapour cell, in order to create a saturation spectroscopy scheme; it is then sent on a rapid photodiode (not illustrated). The photodiode signal is demodulated in quadrature with the EOM modulation signal.

It should be pointed out that the saturation spectroscopy guarantees a narrow reference line, in the order of the natural broadness of the atomic transition between the fundamental energy state and the excited energy state of the atomic species considered; with a S/R ratio in the order of 1,000, it is therefore possible to reach frequency precisions better than 10 kHz. The high modulation frequency of the electro-optical modulator crystal, moreover, permits the noise 1/f during the detection step to be rejected. The frequency shift between the two pump and probe bands, obtained with the acousto-optic modulator crystal, reduces interferences between the two bands.

The first source 23 is advantageously coupled with secondary band generation means 29 comprising a plurality of lenses and mirrors (not illustrated), a plurality of acousto-optic modulators (not illustrated), and a plurality of band dividers (not illustrated) arranged so as to generate a detection band 31, a band for producing the three-dimensional magneto-optical trap 32 and a thrust band 33, which are injected directly into a plurality of optical fibres (not illustrated) suitable for transferring them into the ultra-vacuum system 14.

Such secondary band generation means 29 also generate a reference band 36 for producing of Raman interferometric laser bands.

The first source 23 is preferably also associated with a first optical amplifier 28 which permits a high-power laser band to be obtained, which is indispensable for guaranteeing the generation of the plurality of bands necessary for the functioning of the absolute gravimetric measurement device 10.

The first optical amplifier 28 is preferably of the tapered type as it offers a greater robustness and higher optical power. Such first optical amplifier 28 is situated between the first source 23 and the secondary band generation means 29.

The second source 24, on the other hand, is associated with step connection means 34 into which part of the first band 30 amplified by the above first optical amplifier 28, is also injected.

In this way, a second band 35 emitted by the second source 24 results to be connected in step to the first band 30 emitted by the first source 23 and generates the repumping band 37; it can therefore be affirmed that when it is connected to the first source 23, the second source 24 emits the repumping band 37.

It should be stressed that part of the repumping band 37 is advantageously coupled with the second band generation means 29 so as to cooperate in particular in generating the band for producing the three-dimensional magneto-optical trap 32 and detection band 31.

The first module 25 couples with the second module 26 through the injection enterign said second module 26 of the reference band 36 and repumping band 37.

The second module 26 advantageously comprises a second optical amplifier 38, preferably of the tapered type, into which the reference band 36 coming from the first module 25, is injected.

Said second optical amplifier 38 is coupled with Raman band generation means 39 capable of producing two exiting interferometric Raman bands 41, advantageously superimposed, starting from the reference band 36 alone; said superimposed Raman bands 41 are injected into fibre (not illustrated) for transferring to the ultra-vacuum system 14.

Alternatively, the reference band 36 is injected directly into the Raman band generation means 39.

In particular, as it can be observed in FIG. 4b, said Raman band generation means 39 comprise band separator means 60, suitable for separating the reference band preferably amplified 36 into two tertiary bands 47 and 48.

Downstream of said separator means, the presence of a plurality of focalization lenses and optical mirrors (not illustrated) is provided suitable for injecting the two tertiary bands 47 and 48 into two acousto-optic modulators (AOM) 43 and 44, capable of varying the frequency of the incoming radiation.

In particular, the first 43 and second 44 acousto-optic modulators are capable of respectively shifting the first tertiary band 47 towards the high frequencies and the second tertiary band 48 towards low frequencies, by a quantity equal to about a fourth of the frequency difference between two hyperfine levels of the fundamental state of the atomic species considered.

In case the atomic species is Rubidium 87, the two acousto-optic modulators 43 and 44 are capable of shifting the frequency of a passing band by about 1.7 GHz.

The two acousto-optic modulators 43 and 44 are also associated with reflecting means 50 suitable for favouring the double passage of part of the two tertiary bands 47 and 48 through the same modulators 43 and 44.

As a result, the two bands deriving from said double passage are tuned to frequencies which differ by a quantity corresponding to the energetic transition between the two hyperfine levels of the fundamental state of the atomic species considered and they can therefore be defined as Raman bands 51, 52.

The two Raman bands 51, 52 are advantageously superimposed and injected into a third optical amplifier 46, preferably of the tapered type.

Said third optical amplifier 46 is coupled with a third acousto-optical modulator 45 which suitably shifts the two superimposed Raman bands 41 in frequency.

Furthermore, as the two superimposed Raman bands 41 must be activated with impulses lasting a few tens of microseconds, with a reproducible duration within 0.1%, the third acousto-optical modulator 45 is capable of controlling the intensity of such bands in time intervals of less than a microsecond.

The two superimposed Raman bands 41, exiting from said third acousto-optical modulator 45, are injected into an optical fibre (not illustrated) to be transported up to the inlet of the ultra-vacuum system 14.

Is useful to point out that the choice of combining the bands upstream of the optical fibre, is aimed at limiting the step noise deriving from fluctuations of the independent optical paths, as much as possible.

As it can be seen in FIG. 4a, the Raman band generation means 39 are also advantageously associated with cooling band generation means 40 into which the residual part 54 of the two tertiary bands 47, 48 is injected after the passage through the acousto-optical modulators 43, 44.

These cooling band generation means 40 are additionally coupled with the repumping band 37 deriving from the first module 25 and are capable of generating three bands 53 for producing a two-dimensional magneto-optical trap, suitable for cooling and slowing down the sample of atoms considered in the absolute gravimetric measurement device 10.

All the bands generated by the laser system 13 are transferred by means of a plurality of optical fibres to the ultra-vacuum system 14.

It is also stressed that the Raman band generation means 39, the secondary band generation means 29 and the cooling band generation means also comprise a plurality of mechanical shutters (not illustrated) capable of extinguishing the bands generated when required.

The ultra-vacuum system 14 comprises a primary chamber 61 preferably octagonal, a secondary chamber 63 preferably cubic and positioned below the primary chamber and finally a cylindrical duct 62 which connects the two chambers 61 and 63.

Both the primary chamber 61 and the secondary chamber 63 comprise a plurality of optical windows 64 for injecting laser bands necessary for the functioning of the absolute gravimetric measurement device 10.

The ultra-vacuum system 14 is preferably made of titanium whereas the optical windows are preferably made of BK7 and are welded to the titanium body by means of the diffusion bonding technique.

It should be noted that titanium is a particularly suitable metal for this type of application, due to its magnetic properties and resistance to high temperatures necessary for producing the vacuum chamber, as well as the coincidence of its thermal expansion coefficient with that of BK7.

The pressure in the ultra-vacuum system 14 is maintained at ultra-vacuum levels by pumping means (not illustrated) in order to limit collisions of the atoms involved in the measurement with other atoms at room temperature. These pumping means are housed in specific pass-through seats 65 obtained on the surface of the primary 61 and secondary 63 chambers.

In the ultra-vacuum system 14, the entrapment of the cooled atoms takes place, the Raman interferometric sequence and detection take place, thanks to the action of the bands generated by the laser system 13.

More specifically, the cooling of the sample of atoms occurs due to a magnetic field and to two of the three counter-propagating laser bands 53 for producing a two-dimensional magneto-optical trap (2D-MOT) in a cooling cell (not illustrated) included in the ultra-vacuum system wherein the pressure is maintained by pumping means (not illustrated) at a level of about 10⁻⁷ mbar.

The remaining laser band of the three counter-propagating laser bands 53 for producing a two-dimensional magneto-optical trap pushes the atoms axially towards the primary vacuum chamber, so as to increase the atomic flow.

The entrapment takes place in the primary chamber where analogous pumping means (not illustrated) maintain the pressure at a level of about 10⁻⁹ mbar.

The entrapment takes place due to a three-dimensional magneto-optical trap produced through the injection of at least four bands deriving from the band for producing a magneto-optical trap 32, and the contemporaneous activation of a trap magnetic field generated by two bobbins 66.

Three pairs of counter-propagating and non-coplanar laser bands, deriving from the band for obtaining the three-dimensional magneto-optical trap 32, are preferably injected.

The bobbins 66 are housed in two seats produced on the primary chamber 61, as illustrated in FIG. 5b, so that the same bobbins 66 are situated at the minimum distance possible from the atoms for limiting the thermal power dissipated.

Each of the two bobbins 66 is composed of a number of coils of copper wire so as to generate the magnetic field gradient necessary for the functioning of the magneto-optical trap.

The three-dimensional magneto-optical trap is therefore produced in the primary chamber 61 where the sample of cooled atoms is first introduced and the three pairs of laser bands are then injected through six of the plurality of optical windows 64 obtained in the primary chamber 61 itself.

The injection occurs by means of a first plurality of optics 68 assembled on independent supports (not illustrated) and suitably positioned downstream of the plurality of optical fibres 69 so as to guarantee the alignment of the bands necessary for the entrapment.

The three-dimensional magneto-optical trap is preferably produced through the interaction of three pairs of counter-propagating and non-coplanar laser bands, of which two pairs are tilted by 45° with respect to the vertical, and one pair is arranged along a horizontal direction.

This configuration of the magneto-optical trap is commonly indicated with 1-1-0 and permits a better relation between the miniaturization of the ultra-vacuum system and versatility of the optical accesses.

Alternatively, any configuration with three pairs of counter-propagating and non-coplanar bands or a configuration with four bands having a tetrahedral geometry, can be implemented.

It should be noted that the three-dimensional magneto-optical trap can also be obtained through retroreflection optics starting from a lower number of bands, possibly also from only one; the use of retroreflection optics, however, makes the position of the atoms less stable, due to light absorption by the same atoms, with a consequent intensity unbalancing between the retroreflected bands in relation to the atomic density.

The gravity acceleration measurement is influenced by the effective position of the atoms during the measurement; this depends on the initial position and initial velocity of the atoms, which must therefore be precisely controlled.

For this reason, both the entrapment step and the release step of the cooled atoms are particularly important.

In a preferred embodiment of the present invention, the laser bands of the three-dimensional magneto-optical trap are extinguished together with the trap magnetic field permitting a release of the atomic cloud with an average velocity close to zero.

This free-fall release technique permits an optimum control of the initial velocity to be obtained, and an optimization of the dimensions of the ultra-vacuum system 14 which in this case must comprise the trajectory corresponding to the free fall of the atoms alone.

A dipole optical trap or FORT (Far-Off Resonant dipole Trap) is preferably produced in addition to the three-dimensional magneto-optical trap, by means of at least one focalized laser band (not illustrated) or of a pair of intersected laser bands which are directed into the primary chamber 61 through a second plurality of optics (not illustrated).

The position of such second plurality of optics is preferably made stable at the level of a few microns through the use of a mechanical structure (not illustrated) for supporting the same in a sufficiently rigid manner.

The generation of the band for creating a dipole optical trap is preferably derived from the band emitted from the second source 24 advantageously injected into an optical amplifier (not illustrated); such band for creating a dipole optical trap is otherwise generated by a third laser source (not illustrated) having a different wavelength, with less restricted requisites in terms of spectral purity, for example a diode from 500 mW to 810 nm or 850 nm.

It should also be pointed out that the linear dimensions of the dipole optical trap are advantageously in the order of hundreds of microns, in order to maximize the quantity of entrapped atoms.

Highly asymmetrical geometries of the trap can also be created, in order to simultaneously optimize the quantity of atoms and spatial resolution along the measurement axis.

The cooled sample of atoms is then transferred from the three-dimensional magneto-optical trap to the dipole optical trap to be subsequently released in free fall from the latter.

In any case, after the release of the magneto-optical trap, the cooled atoms are free to fall under the action of gravitational force.

The free fall takes place in the cylindrical duct 62 which connects the primary chamber 61 to the secondary chamber 63.

During the free fall in the duct 62, the atoms are subjected to the action of the superimposed Raman interferometric laser bands 41. These bands are injected in a vertical direction into the primary chamber through an optical window, they passing through the duct 62 and secondary chamber 63 and exit from the ultra-vacuum system 14 to be subsequently retroreflected by the retroreflective mirror 21.

After the interferometric sequence, the atoms are on two hyperfine levels F₁ and F₂ of the fundamental state of the particular atomic species considered.

At this point, a detection step is necessary for measuring the ratio between the atomic populations in the two hyperfine sub levels F₁ and F₂ of the fundamental state in order to obtain an estimate of the step shift between the matter waves associated with them and thus measuring the gravity acceleration g.

According to the present invention, it is possible to implement not only the simultaneous detection technique in separate areas and the separate area sequential detection technique, but also the sequential detection technique in a single area.

According to this detection scheme, the atoms in the two hyperfine sublevels F₁ and F₂ of the fundamental state are first separated with a selective vertical thrust obtained by means of the thrust band 33 and they then pass in sequence through a single interaction area with the detection band.

As the separation between the atomic clouds is purely vertical, these can obviously pass through the same detection area in different times.

This technique reduces numerous systematic errors present in detection in separate areas; the calibration of the separate area detection is in fact particularly delicate as the detection efficiency is intrinsically different for the two channels due to the different geometry of the detection optics and the different opto-electronic devices used in the two distinct areas.

Starting from above downwards, following the vertical direction defined by the force of gravity, the absolute gravimetric measurement device 10 of the present invention generally comprises a laser system 13, a supporting surface 16, an ultra-vacuum system 14, a retroreflective mirror 21 and a seismic attenuation system 15.

In order to guarantee a high measurement accuracy, the vibrations of the absolute gravimetric measurement device 10 along its vertical axis must be reduced to the minimum, in particular the vibrations along the vertical direction of the retroreflective mirror 21, and the above components of the absolute gravimetric measurement device 10 must be kept as aligned as possible along the vertical direction.

Furthermore, the seismic attenuation system 15 suitable for guaranteeing such specifications must have reduced encumbrances so as to permit it to be installed in a transportable absolute gravimetric measurement device 10, as provided by the present invention. The above specifications are guaranteed to the absolute gravimetric measurement device 10 by means of the seismic attenuation system 15, object of the present invention.

The vertical damping of the retroreflective mirror 21 occurs by decoupling the same from ground vibrations within the time range necessary for the interferometric sequence.

In order to attenuate seismic noise, preferably by at least 40 dB, the seismic attenuation system 15 is installed specifically below the retroreflective mirror 21.

As it can be seen in FIG. 8, said seismic attenuation system 15 comprises a supporting lower plate 1000, possibly equipped below with resting feet 1001, of the absolute gravimetric measurement device 10 on the ground or on any other structure. The seismic attenuation system 15 also comprises an upper supporting plate 1002 of the retroreflective mirror 21 equipped with a pass-through hole 1003. The retroreflective mirror 21 is kept suspended above said pass-through hole 1003 by means of a geometrical spring-anti-spring coupling, in itself of the known type, comprising three metallic blades 70, 71, 72 arranged and constrained in a configuration which is such as to produce the above spring-anti-spring coupling.

The number of metallic blades can naturally also be greater than three.

The lower plate 1000 is connected to the upper plate 1002 by means of articulated arms 1008 carrying spherical joints 1009 at the ends.

These articulated arms 1008 permit the levelling of the retroreflective mirror 21 by means of a rod element 1010 which, starting from an upper spherical joint 1009, passes through an elongated base 1011 of the retroreflective mirror 21 beneath the upper plate 1002 up to a relative seat 1012 in turn constrained beneath the upper plate 1002.

Through this spring-anti-spring geometry of the type with metallic blades 70, 71, 72 which keep the retroreflective mirror 21 suspended, it is possible to modify the resonance frequencies of the vertical movement of the retroreflective mirror 21 by varying the distance of the anchoring point of the base of each blade 70, 71, 72 to the upper plate 1002.

In such spring-anti-spring geometry, the bases of the blades 70, 71, 72 constrained to the upper plate 1002 work in flexion and act like ordinary springs with a positive rigidity, whereas their heads, reciprocally opposing each other in the point where they keep the retroreflective mirror 21 raised, work in compression like an anti-spring with a negative rigidity.

The composition of these two springs can reduce the overall rigidity value to very low values, limited by the occurrence of the bistable behaviour of the system which is obtained through almost zero effective rigidity values, where the system would be in a state of indifferent equilibrium.

In order to guarantee a high angular rigidity and for opposing any possible shifts in the plane orthogonal to the vertical direction, along which the damping acts, the invention provides radial constraint means between the retroreflective mirror 21 and the upper plate 1002.

According to the embodiment shown, these radial constraint means comprise tie-rod elements 1005 fixed on one side beneath the retroreflective mirror 21 and on another side to the upper plate 1002 by means of drawing devices 1006 in turn fixed to the upper plate 1002.

As already cited above, the mirror 21 must keep its axis aligned along the vertical direction preferably within an angle of about 50 microradiants.

The monitoring of the alignment occurs using measurement means of the inclination of the retroreflective mirror 21 integral with the seismic attenuation system 15 itself.

According to the embodiment example illustrated, the measurement means of the inclination comprise a tetrahedral element 1013 facing the lower plate 1000 and constrained beneath the lower elongated portion 111 of the retroreflective mirror 21.

Such tetrahedral element 1013 acts as reflection element for rays 1016 generated by a source placed on the lower plate 1000 beneath said tetrahedral element 1013.

In particular, the tetrahedron 1013 deviates the rays onto suitable receiving elements 1015 constrained to the lower plate 1000.

In this way, when at least one of the receiving elements 1015 is not struck by the relative reflected ray 1017, a relative excessive inclination of the retroreflective mirror 21 is indicated, above the level tolerated.

The possible correction of the excessive inclination of the retroreflective mirror 21 is carried out by acting manually, or automatically, by means of a specific motorization, on regulation screws integrated in the articulated arms 1008.

The piloting method 100 of the laser system 13 comprises a generation step 101 of the cooling, entrapment, manipulation, thrust and detection bands of a plurality of atoms through the ignition of the two sources 23, 24.

After this generation step, the cooling step 102 of the above plurality of atoms is provided, which occurs through the activation and injection into the cooling cell 102 of the counter-propagating bands for producing a two-dimensional magneto-optical trap 53.

At the end of the cooling step 102, the counter-propagating bands for producing a two-dimensional magneto-optical trap 53 are extinguished and the entrapment step 103 of the plurality of atoms cooled in the primary chamber 61 of the ultra-vacuum system 14 is then carried out.

Said entrapment step 103 takes place through the activation and injection of the bands for producing a three-dimensional magneto-optical trap 32, and also through the contemporaneous generation of the trap magnetic field produced by the two bobbins 66.

After the entrapment step 103, the free-fall release step 104 is provided, which, according to the present invention, comprises the quenching step 109 of the three-dimensional magneto-optical trap through the contemporaneous extinguishing of the bands for producing a three-dimensional magneto-optical trap 32 and the trap magnetic field produced by the two bobbins 66.

After quenching the three-dimensional magneto-optical trap, the cooled atoms are free to fall under the action of gravitational force; it is obviously important to also accurately know the initial position of the atoms which, however, can be influenced by fluctuations of the relative intensity between the laser bands, in the polarization of the laser bands, in the optical frequency of the laser bands. All these parameters are influenced by technical factors such as temperature fluctuations and vibrations of the apparatus, limiting the stability and accuracy of the atomic gravimeter.

In a preferred embodiment, the release step 104 advantageously additionally comprises a transfer step 105 wherein the atoms entrapped in the three-dimensional magneto-optical trap are transferred to a dipole optical trap.

Said transfer step 105 takes place by activating the band for producing a dipole optical trap following the quenching of the three-dimensional magneto-optical trap.

The transfer step 105 is followed by the freeing step 106 of the plurality of atoms wherein the band for producing a dipole optical trap is extinguished leaving the atoms free to fall.

After the transfer step 105 and before the freeing step 106 a further cooling step (not illustrated) of the sample of atoms preferably takes place by means of techniques such as “Raman sideband cooling” and/or evaporative cooling, in order to reduce the effects of the atomic velocity dispersion on the interferometric measurement.

The “Raman sideband cooling” technique is based on the fact that the atoms entrapped in preservative potentials, such as the dipole optical trap, oscillate with discreet energy levels, as they can only have a discreet combination of vibrational energy values.

By activating a pair of laser bands to induce Raman transitions on the atom sample, the atoms transfer to the lowest vibrational energy level. In this way, for each Raman transition, an atom transfers to the laser bands an energy equivalent to the energy difference between the photon absorbed and the photon emitted, and the cooling derives from this energy loss. Temperatures in the order of 100 nanoKelvin in a few milliseconds have been obtained with this technique on samples of Caesium; with Rubidium 87 atoms, on the other hand, temperatures lower than 800 nanoKelvin have not been observed.

Evaporative cooling in a dipole optical trap is based on the spontaneous selective loss phenomenon of the most energetic atoms of the entrapped sample; the atoms having a greater energy than a certain threshold cannot be entrapped and after a certain time they leave the sample; the loss of “hot” atoms causes a decrease in the average thermal energy of the sample, thus of the atomic temperature. In order to increase the cooling rate and efficiency, the threshold energy is reduced by evaporation, reducing the intensity of the optic trap lasers (forced evaporation), so as to maintain the ratio between the threshold energy and the average temperature sufficiently low. Evaporative cooling permits extremely low temperatures to be reached (nanoKelvin) but causes a considerable decrease in the number of atoms, and generally requires lengthy times (from a few seconds to tens of seconds) to permit the thermalization of the sample.

This further cooling step can be forced until the quantistic degeneration condition has been reached (Bose-Einstein condensation or Fermi gas degeneracy, depending on the atomic spin moment) in order to use certain quantistic coherence properties for improving the sensitivity and accuracy of the gravimeter 10.

At the end of the release step 104, an interferometric sequence 107 is carried out through the activation of the superimposed Raman interferometric bands 41 during the free fall of the plurality of atoms through the cylindrical duct 62.

After the interferometric sequence, the superimposed Raman interferometric bands 41 are extinguished and the detection step 108 is carried out by activating the thrust bands 33 and detection bands 31 in accordance with the implemented detection technique.

More specifically, the detection step 108 is preferably carried out through the implementation of the single area sequential detection technique.

Alternatively, the detection step 108 is carried out through the implementation of the simultaneous detection technique in separate areas or the sequential detection technique in separate areas.

It should be pointed out that the control of the intensity and consequently the activation and extinction of the laser bands involved in the measurement process, occurs through a combination of the use of a plurality of electro-optical activation modulators and mechanical shutters included in the laser system 13.

In particular, electro-optical activation modulators are used for bands wherein an extinction and/or activation with a maximum time precision is necessary, whereas the plurality of mechanical shutters is used when the time precision is not critical and/or when a complete extinction of the band is important, as electro-optical activation modulators do not guarantee the complete extinction; finally, for bands for which both time precision and complete extinction are required, one of the plurality of electro-optical activation modulators and one of the plurality of shutters are used in cascade.

The characteristics, as well as the relative advantages, of the absolute gravimetric measurement device by atomic interferometry, object of the present invention, are clear from the above description.

Said absolute gravimetric measurement device by atomic interferometry, in fact, comprises a laser system capable of generating all the laser bands necessary for the functioning of the absolute gravimetric measurement device itself from only two laser sources.

This means that this laser system can be installed on compact modules which are preferably situated at the measurement head of the absolute gravimetric measurement device, giving the latter compact dimensions and making it easy to transport.

Furthermore, as the measurement head is positioned inside a thermostat-regulated frame, it is possible to control thermal fluctuations of the optical fibres used for transferring the plurality of bands generated by the laser system to the ultra-vacuum system.

All of this also permits reliable on-site measurements to be effected.

The laser system according to the present invention, in fact, guarantees a high spectral purity of the sources (frequency and step quality control), intensity stability and optical power supplied.

The spectral purity is ensured by the use of a narrow-line ECDL laser, stabilized with the Modulation Transfer Spectroscopy technique, which guarantees a high frequency stability. The relative step stability of Raman lasers is guaranteed by the use of high-frequency acousto-optic modulators, instead of optical step connection between two lasers in use in other apparatuses. As far as the intensity stability is concerned, the use of miniaturized optical components is an advantage as it guarantees a greater alignment stability.

Finally, the total power available is comparable to or higher than that of other laboratory gravimetric devices, due to the use of three optical amplifiers.

The piloting method of the laser system according to the present invention, by implementing the free-fall release technique, permits the dimensions of the ultra-vacuum system to be reduced, and to obtain an optimum control of the initial velocity of the atoms.

The creation step of a dipole optical trap in which the atoms are transferred from the magneto-optical trap before their free-fall release permits a high-precision control of the position of the atoms at the moment when the free fall begins.

In this case, in fact, the initial position of the atoms only depends on the position of the second plurality of optics through which the at least one focalized band is injected.

Furthermore, the alternative seismic attenuation system described in the present invention, on the one hand, has a reduced encumbrance and, on the other, not only reduces vibrations along the vertical direction of the retroreflective mirror to the minimum, but also keeps the components of the absolute gravimetric measurement device as aligned as possible along the vertical direction.

Finally, the absolute gravimetric measurement device by atomic interferometry thus conceived can obviously undergo numerous modifications and variants, all included in the invention; furthermore, all the details can be replaced by technically equivalent elements. In practice, the materials used, as also the dimensions, can vary according to technical requirements.

1-9. (canceled)

10. An absolute gravimetric measurement device comprising, arranged in downward succession along a vertical direction defined by force of gravity:
a laser system for generation of laser bands;
a supporting surface of the laser system;
an ultra-vacuum system for passage of the laser bands;
a retroreflective mirror for the laser bands leaving the ultra-vacuum system;
a seismic attenuation system, the seismic attenuation system comprising an upper plate including a hole above which the retroreflective mirror is kept suspended by at least three metallic blades, the three metallic blades comprising first ends constrained to a periphery of the plate and second ends above the hole in correspondence with the retroreflective mirror, the three metallic blades configured to form a spring-antispring geometry for damping vibrations of the retroreflective mirror along the vertical direction;
means for leveling the retroreflective mirror integral with the seismic attenuation system; and
radial constraining means between the retroreflective mirror and the upper plate acting in the plane orthogonal to the vertical direction.

11. The device according to claim 10, further comprising a lower plate for resting the device on the ground, the means for levelling of the retroreflective mirror comprising at least three articulated arms including spherical joints at their ends for connecting the lower plate to the upper plate.

12. The device according to claim 11, wherein the leveling means of the retroreflective mirror further comprises a rod element which, starting from one of the spherical joints constrained to the upper plate, passes through an elongated base of the retroreflective mirror that protrudes below the upper plate.

13. The device according to claim 10, further comprising means for measuring inclination of the retroreflective mirror integral with the seismic attenuation system.

14. The device according to claim 13, wherein the means for measuring the inclination comprises a tetrahedron element constrained below a lower elongated portion of the retroreflective mirror facing a laser source positioned on the lower plate, the tetrahedron reflecting the laser bands generated by the laser source towards vertical receiver elements constrained to the lower plate.

15. The device according to claim 14, further comprising actuator means driven by the vertical receiver elements for levelling of the retroreflective mirror.

16. The device according to claim 15, wherein the actuator means is driven by the vertical receiver elements for the levelling of the retroreflective mirror and comprises a motorization acting on regulation screws positioned in the articulated arms.

17. The device according to claim 10, wherein the radial constraining means comprises radial tie-rod elements fixed to below the retroreflective mirror and to the periphery of the upper plate.

18. The device according to claim 17, further comprising drawing devices of the radial tie-rod elements fixed above the upper plate.
